(19) United States
(12) Patent Application Publication
(10) Pub. No.: US 2019/0084272 A1
(43) Pub. Date: Mar. 21, 2019

(54) Variable Adhesion for Removable, Architectural Glass Insulation

(71) Applicant: Mark Anthony Shippen, Prattville, AL (US)

(72) Inventor: Mark Anthony Shippen, Prattville, AL (US)

(73) Assignee: Mark Anthony Shippen, Prattville, AL (US)

(21) Appl. No.: 15/706,643

(22) Filed: Sep. 15, 2017

(51) Int. Cl. B32B 7/14; B32B 13/04; B32B 27/30; B32B 17/10; B32B 27/06; B32B 27/08

(52) U.S. Cl. CPC B32B 7/14; B32B 13/045; B32B 27/304; B32B 2037/1276; B32B 27/065; B32B 27/08; B32B 2307/7242; B32B 17/10568

(57) ABSTRACT

Architectural glass can be insulated effectively with plastic foam laminates. This invention discloses a way to reduce the adhesion of strong, permanent adhesive compositions so that these adhesive surfaces will be modified to become removable from glass. The deposition of relatively inert particulate matter on at least part of the permanent adhesive composition can yield variable adhesion to glass, a highly desirable property. Since the plastic foam laminates can exceed 90% reduction in heat transfer from glass, and glass is such a desired material of construction, the need for this invention is great including substantial environmental preservation.

### FIELD OF INVENTION

This paper discloses a way to reduce the adhesion of permanent, aggressive, waterproof adhesive films so that such adhesive films can release from glass cleanly and easily. These modified, variable adhesive films then become glass removable adhesive films which simply means an adhesive removable from glass. Double sided, glass removable, adhesive films and transfer films find particular utility when applied to plastic foam laminates. Such adhesives films are very desirable when they release from glass as easy as Velcro. This alteration can be accomplished by depositing particulate matter on the surface area of the aggressive bonding, adhesive films. The resultant, variable adhesion is very useful given the large areas required to insulate architectural glass. These plastic foam laminates can exceed 90% heat transfer reduction through glass.

### PRIOR ART

Shippen, this current applicant, discloses in US 2015/0354209, glass removable, adhesive applications for plastic foam laminates. These glass removable, adhesive films are limited to adhesive films that are commercially available. With this in view, double sided, glass removable tapes have found great utility for these plastic foam laminates. Due to the effects of condensation on glass, water resistant adhesives such as rubber, synthetic rubber, solvent rubber, silicone and solvent acrylics are preferred compositions for the glass removable, adhesive films. Typically, such adhesive films are formulated and sold as aggressive, permanent adhesive films which are not glass removable types. Also, Shippen's glass removable adhesive, plastic foam laminates vary in required adhesion based upon the number and thickness of the laminate's sub layers. Also mild adhesive compositions which are classified as removable types have inadequate internal cohesion and can deposit residue on glass when removed. A higher peel strength yields higher internal cohesion of the adhesive composition which eliminates residual adhesive deposits on glass. A means to reduce the adhesion of the waterproof, aggressive adhesive films to form a glass removable type is highly desired. This patent discloses an inexpensive, reliable way to reduce adhesion thereby eliminating the need for significant chemical reformulation of the water resistant adhesives. This invention can create glass removable adhesion for all plastic foam laminates which now can be easily removed when mounted on architectural glass.

### Embodiments

The main embodiment is a double sided, condensation resistant, adhesive film or transfer film composed of rubber, synthetic rubber, solvent rubber, silicone, or solvent acrylic type composition. The rubber type adhesive composition can start with a stainless steel peel strength of 73 ounces per inch (20.9 N/25 mm) or more. The silicone type can start with a peel strength of 40 ounces per inch (11.5 N/25 mm) or more. The solvent acrylic type can start with an initial peel strength of 45 ounces per inch or (12.9 N/25 mm). All of these materials are extremely difficult to remove from glass when tested as a double sided, adhesive film. Applications at least 0.09 sq. meters in size are most common and can be quite problematic for standard adhesive compositions. Removable, solvent acrylic types of 9.6 ounces per inch (2.7N/25 mm) have low internal cohesion and can leave deposits on glass surfaces which are rated removable for a maximum six months. Now these modified adhesives have improved internal cohesion and the same peel strength as those currently classified as removable from glass. Elimination of adhesive deposits on the glass can be achieved now.

The second embodiment is a water resistant, particulate matter that can be sprinkled on one surface of the double sided, adhesive film. Effectively selecting the size and coverage pattern reduces the aggressive adhesive bond and converts the adhesive film's surface into a glass removable adhesive surface suitable for use on Shippen's plastic foam laminates. One type of particulate that works well is a small iridescent glitter. Most thin, plastic particulate visually desirable can be utilized effectively. Sparkle type glitter and the like can be used to create visual effects.

To achieve the proper pattern deposited on the adhesive film, background materials such as dark colored, nylon fabric, blue painter's tape, colored polyethylene foam or siliconized polyester film which are relatively inert can provide a means to visualize the amount and pattern of the particulate prior to deposition on the adhesive film. Next, a unit of plastic foam laminate can be pressed upon the relatively inert background seeded with particulate. Removal from the background permanently adheres the particulate to the adhesive. With this technique, simple experiments determine the particulates required to reduce a permanent adhesive into a glass removable adhesive film. This technique is especially suited for the large area applications of the plastic foam laminates which require a glass removable adhesive to function effectively.

### DRAWINGS

FIG. 1 is a sectional view of a double sided adhesive film with a plastic film(2) and a permanent adhesive composition(1) with a glass removable adhesive(3) formed by the deposition of particulates(4) to achieve variable adhesion.

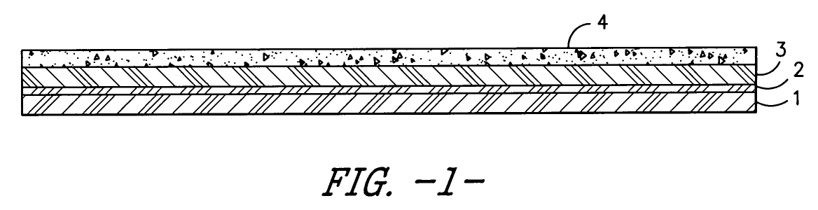

FIG. 2 is a depiction of a typical plastic foam insulating laminate with multiple lamination layers of film, adhesives and plastic foam.

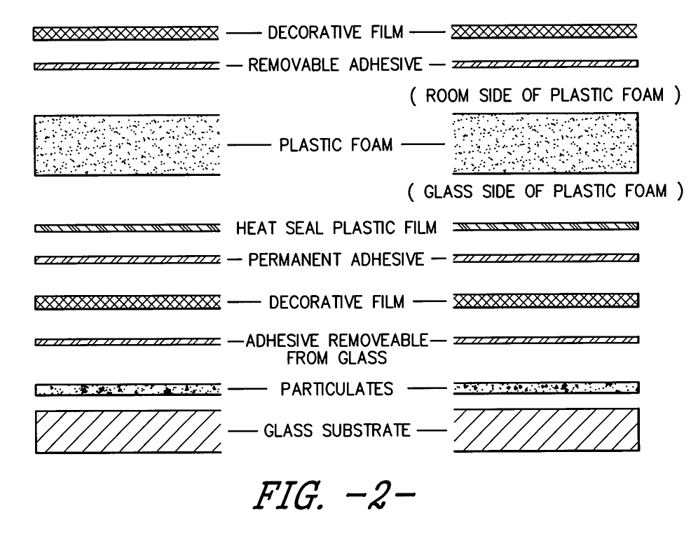

### APPLICATIONS

The primary application of these modified, adhesive films or compositions is for the field of plastic foam laminates. Large areas of the insulation must be glass removable. Conventional adhesives are too aggressive for easy removal from glass. With this present modification of adhesion, all shapes of plastic foam laminates can be cut including curved pieces and/or factory die cut pieces to make attractive insulation in homes, schools and commercial businesses. The insulation value created with the glass removable, plastic foam laminates can exceed 90% reductions in heat transfer.

Furthermore, this adhesive can be laminated to other insulation materials to effect substantial insulation value. Included are bubble wrap, textile fabric, and textile fibers and any other materials that have insulation value. However, the light transmission, the narrow width, the ease of cutting, the commercial availability and the artistic desirability make polyethylene foam the most desirable material of construction.

Similarly, particulates can be applied to water based adhesive compositions if their use is specified for relatively dry applications. Then, water based acrylic compositions can be used. Arid and very dry climates without significant glass condensation can use the water based adhesives. These applications, however, are limited.

### EXAMPLE

A glass removable, plastic foam laminate was adhered to 68 square feet (6.32 square meters) of double pane window glass in a home in Prattville, Ala. USA. The total glass area of the home is approximately 148 square feet (13.7 square meters). The annual heating degree days is approximately 2250 and the annual cooling degree days is approximately 2250. The home uses electric cooling at $0.14 per kilowatt hour. The home uses propane heating at $3.00 per gallon. The electrical savings observed was $517 per year with a 25.5% reduction in air conditioning and mechanical wear depreciation. The propane savings was $481 reducing by 24.1% the heater depreciation. This result yields an annual savings of $15 per square foot of insulation. This savings amounts to the total material cost of the insulated window glass and frame. Furthermore, the six year pay back for many applications will be more than 20 times the cost of the insulating material. In addition to the energy savings, a windfall for the home, a windfall for the economy and a windfall for the environment will follow.

I claim:

1) An exposed adhesive surface on a plastic foam laminate physically altered to be removable from architectural glass comprising:
a water resistant adhesive composition with reduced surface adhesion induced by the deposition of relatively inert particulate matter on at least part of the adhesive surface.

2) The water resistant adhesive composition of claim 1 wherein, an adhesive removable from a glass surface results from the deposition of relatively inert particulate matter thereon.

3) The water resistant adhesive composition of claim 1 wherein, said adhesive composition is chosen from the group including rubber, synthetic rubber, solvent rubber, silicone or acrylic.

4) The water resistant adhesive composition of claim 1 wherein, said adhesive composition is chosen from the group including double sided adhesive film or adhesive transfer film meaning no carrier film with only the chemical adhesive present.

5) The water resistant adhesive composition of claim 4 wherein, at least one adhesive removable from a glass surface results from the deposition of relatively inert particulate matter thereon.

6) The water resistant adhesive composition of claim 4 wherein, at least one adhesive composition on the double sided adhesive film is chosen from the group including rubber, synthetic rubber, solvent rubber, silicone or acrylic.
